(19) United States
(12) Patent Application Publication
(10) Pub. No.: US 2026/0096671 A1
(43) Pub. Date: Apr. 9, 2026

(54) HORIZONTAL DISPLAY FREEZER AND USE METHOD THEREOF

(71) Applicant: QINGDAO HIRON COMMERCIAL COLD CHAIN CO., LTD., QINGDAO (CN)

(72) Inventors: SHANMIN YIN, QINGDAO (CN); YONGJUN ZHANG, QINGDAO (CN); HONGKUI MA, QINGDAO (CN); YONGJIE XU, QINGDAO (CN); RUIXIANG ZHANG, QINGDAO (CN); XIUHUA XIANG, QINGDAO (CN)

(73) Assignee: QINGDAO HIRON COMMERCIAL COLD CHAIN CO., LTD., QINGDAO (CN)

(21) Appl. No.: 19/417,237

(22) Filed: Dec. 11, 2025

Related U.S. Application Data
(63) Continuation of application No. PCT/CN2024/101251, filed on Jun. 25, 2024.

(30) Foreign Application Priority Data
Jun. 30, 2023 (CN) 202310797419.3
Jun. 30, 2023 (CN) 202310801529.2
Jun. 30, 2023 (CN) 202321704890.5
Jun. 30, 2023 (CN) 202321705525.6
Jun. 30, 2023 (CN) 202321705551.9
Aug. 31, 2023 (CN) 202322357428.9
Jun. 3, 2024 (CN) 202421245626.4

(51) Int. Cl. A47F 3/04

(52) U.S. Cl. CPC A47F 3/043

(57) ABSTRACT

The present application provides a horizontal display freezer and use method thereof; the freezer comprises a freezer body, which has a freezer opening, and a door body is mounted at the freezer opening; the door body comprises a front door and a rear door, the rear door is fixedly mounted at a rear end of the freezer opening, and the front door is slidably mounted at a front end thereof; a height of the front end of the freezer opening is lower than the rear end, thus the door body is inclined arranged, and the front door slides down and closes the freezer opening under gravity; the freezer opening is equipped with a guide rail, and the front door has a guide wheel, being able to slide on the guide rail; the guide rail is provided with a positioning groove, and when the front door closes the freezer opening, the guide wheel is located in the positioning groove and a bottom surface of the front door is in contact with a surface of the guide rail. The front door of the freezer can be closed automatically under gravity, preventing cold loss and high energy consumption caused by forgetting to close the front door.

### CROSS-REFERENCE TO RELATED APPLICATIONS

The present application is a continuation of the international application PCT/CN2024/101251 filed on Jun. 25, 2024, which claims the priority benefits of China application No. 202310801529.2, entitled “Anti-Theft Door Body Structure of Horizontal Display Freezer”, filed on Jun. 30, 2023; China application No. 202321704890.5, entitled “Door Body Structure of Horizontal Display Freezer”, filed on Jun. 30, 2023; China application No. 202321705525.6, entitled “Horizontal Display Freezer”, filed on Jun. 30, 2023; China application No. 202310797419.3, entitled “Horizontal Display Freezer and Use Method Thereof”, filed on Jun. 30, 2023; China application No. 202321705551.9, entitled “Inner Shell Structure of Horizontal Display Freezer”, filed on Jun. 30, 2023; China application No. 202322357428.9, entitled “Locking Structure of Door Body of Horizontal Display Freezer”, filed on Aug. 31, 2023; and China application No. 202421245626.4, entitled “Locking Structure of Door Body of Horizontal Display Freezer”, filed on Jun. 3, 2024. The entireties of the above identified applications are hereby incorporated by reference.

### TECHNICAL FIELD

The present application belongs to the technical field of freezing and refrigerating equipment, and particularly relates to a horizontal display freezer and use method thereof.

### BACKGROUND ART

A horizontal display freezer is a freezing and refrigerating device with a freezer opening at the top and a door body arranged on the freezer opening has transparent glasses. The door body of the horizontal display freezer is generally opened and closed in a push-pull manner. After customers open the door body to open the freezer opening, the goods in the freezer body are taken out; when the customers leave, the door body is often forgotten to close, so that the freezer opening keeps open, the cold energy inside of the freezer body is dissipated outwards, the temperature in the freezer body is increased, the goods are easy to melt, and the display freezer also increases the running output due to the increase of the internal temperature, thereby increasing the energy consumption of the display freezer.

### SUMMARY OF THE INVENTION

To address at least one deficiency in the prior art, the present application provides a horizontal display freezer and use method thereof.

An aspect of the present application provides a horizontal display freezer, comprising a freezer body; the freezer body has a freezer opening, and a door body is mounted at the freezer opening;
the door body comprises a front door and a rear door, the rear door is fixedly mounted at a rear end of the freezer opening, and the front door is slidably mounted at a front end of the freezer opening; a height of the front end of the freezer opening is lower than a height of the rear end, so that the door body is inclined arranged, and the front door slides down and closes the freezer opening under an action of gravity;
the freezer opening is equipped with a guide rail, and the front door is provided with a guide wheel, being able to slide on the guide rail; the guide rail is provided with a positioning groove, and when the front door closes the freezer opening, the guide wheel is located in the positioning groove and a bottom surface of the front door is in contact with a surface of the guide rail.

Another aspect of the present application provides a use method of the above horizontal display freezer, wherein in the horizontal display freezer, the positioning groove comprises a first positioning groove located at a front end of the guide rail and a second positioning groove located at a rear side of the first positioning groove, and the guide wheel comprises a first guide wheel located at a front end of the front door and a second guide wheel located at a rear end of the front door; when the front door closes the freezer opening, the first guide wheel is located in the first positioning groove, and the second guide wheel is located in the second positioning groove; when the front door opens the freezer opening, the first guide wheel slides on the guide rail between the first positioning groove and the second positioning groove; and the use method of the horizontal display freezer comprises the following steps:
S1: pushing the front door backward by a first arm, pushing the first guide wheel out of the first positioning groove, and pushing the second guide wheel out of the second positioning groove;
S2: pushing the front door backward continually by the first arm, pushing both the first guide wheel and the second guide wheel onto the surface of the guide rail and sliding backward along the guide rail, until an open space through which one arm is able to pass is formed between the front end of the front door and the front end of the freezer opening;
S3: holding the front door by the first arm, keeping the front door suspended; reaching into the freezer body through the open space to retrieve goods inside the freezer body by a second arm;
S4: leaving the front door by the first arm, and under the action of gravity of the front door, the first guide wheel and the second guide wheel being sliding forward along the guide rail until falling into the first positioning groove and the second positioning groove respectively, and the freezer opening being closed by the front door.

Compared with the prior art, the present application has the following beneficial effects:

According to the horizontal display freezer provided by at least one embodiment of the present application, the door body is divided into the front door and the rear door; the freezer opening is obliquely arranged, the rear door is fixedly mounted, sealed the rear end of the freezer opening stably, and the front door is in sliding fit with the guide rail on the freezer opening by the guide wheel. During use, after a customer pulls the front door to open the freezer opening to pick up goods, the front door is released, and the inclined freezer opening allows the front door to slide under gravity and close the front end of the freezer opening, so that the door body can be closed automatically when the external force is removed, and the freezer body is kept closed, thereby the problem of cold loss caused by the door body forgetting to close and increasing the power consumption of the display freezer is avoided, and the problem of the existing display freezer being prone to cold loss due to forgetting to close the door, and the energy consumption being increased is solved.

### BRIEF DESCRIPTION OF THE DRAWINGS

FIG. 1a is a first schematic diagram of a horizontal display freezer according to an embodiment of the present application;

FIG. 1b is a second schematic diagram of the horizontal display freezer;

FIG. 2a is a cross-sectional view of the horizontal display freezer;

FIG. 2b is a partial enlarged view of part A in FIG. 2a;

FIG. 2c is a partial enlarged view of part B in FIG. 2a;

FIG. 3a is a cross-sectional view of a freezer opening of the horizontal display freezer, wherein a front door is in a closed state;

FIG. 3b is a partial enlarged view of part C in FIG. 3a;

FIG. 3c is a partial enlarged view of part D in FIG. 3a;

FIG. 4a is a cross-sectional view of the freezer opening of the horizontal display freezer, wherein the front door is in a maximum opening state;

FIG. 4b is a partial enlarged view of part E in FIG. 4a;

FIG. 5 is a schematic diagram of camera arrangement in the horizontal display freezer according to an embodiment of the present application;

FIG. 6a is a schematic diagram of the horizontal display freezer, with one front door removed;

FIG. 6b is a partial enlarged view of the opened freezer opening in FIG. 6a;

FIG. 7 is a top view of the front door of the horizontal display freezer;

FIG. 8a is a schematic diagram of the horizontal display freezer with partial housing removed at the freezer opening according to an embodiment of the present application;

FIG. 8b is a partial enlarged view of part F in FIG. 8a, illustrating a matching state of a protrusion portion with a power buffering device during the opening of the front door;

FIG. 9a is a schematic diagram of one side of a shell of the horizontal display freezer installed at the freezer opening according to an embodiment of the present application;

FIG. 9b is a schematic diagram of another side of the shell of the horizontal display freezer installed at the freezer opening;

FIG. 9c is a partial enlarged view of part G in FIG. 9b;

FIG. 10a is a schematic diagram of the display freezer shown in FIG. 6a with the shell removed;

FIG. 10b is a partial enlarged view at the freezer opening in FIG. 10a;

FIG. 10c is a partial enlarged view at the freezer opening of the display freezer shown in FIG. 6a viewed obliquely upward from inside an accommodating chamber;

FIG. 11a is a schematic diagram the horizontal display freezer with a rear door removed, wherein other components above the freezer opening are removed to clearly show a mounting groove;

FIG. 11b is a partial enlarged view of the opened freezer opening in FIG. 11a;

FIG. 12a is a schematic diagram of the horizontal display freezer with a back cover plate removed;

FIG. 12b is a partial enlarged view of part H in FIG. 12a;

FIG. 13a is a schematic diagram of the display freezer shown in FIG. 12a with the housing at the rear part of the freezer opening further removed;

FIG. 13b is a partial enlarged view of part I in FIG. 13a;

FIG. 14a is a first schematic diagram of an edge-pressing strip installed in the horizontal display freezer in the present application;

FIG. 14b is a second schematic diagram of the edge-pressing strip;

FIG. 15 is a cross-sectional view of the edge-pressing strip being assembled with the partition in the horizontal display freezer, wherein only the top of the partition is shown;

FIG. 16a is a third schematic diagram of the horizontal display freezer provided in the present application, with the front door in a closed state;

FIG. 16b is a partial enlarged view of part J in FIG. 16a;

FIG. 17a is a schematic diagram of the horizontal display freezer shown in FIG. 16a with one front door removed;

FIG. 17b is a partial enlarged view of part K in FIG. 17a;

FIG. 18a is a first schematic diagram of the freezer opening of the horizontal display freezer (the front door open and locked);

FIG. 18b is a partial enlarged view of part L in FIG. 18a;

FIG. 19a is a schematic diagram of the freezer opening of the horizontal display freezer (the front door closed and locked);

FIG. 19b is a partial enlarged view of part M in FIG. 19a;

FIG. 20a is a schematic diagram of the front door of the horizontal display freezer viewed obliquely upward in a direction away from the rotating member;

FIG. 20b is a schematic diagram of the front door of the horizontal display freezer viewed obliquely upward in a direction facing the rotating member;

FIG. 21 is a structural block diagram of the sensing member, driving member, and controller in the horizontal display freezer;

FIG. 22 is a flowchart of a use method of the horizontal display freezer of the present application.

### DETAILED DESCRIPTION OF THE EMBODIMENTS

The technical solutions in the embodiments will be clearly and completely described below with reference to the accompanying drawings. Obviously, the described embodiments are only a part of the embodiments of the application, not all of them. All other embodiments obtained by those skilled in the art based on the embodiments of the present application without creative effort are within the scope of protection of the present application.

In the description of the application, it should be understood that the terms “lateral”, “longitudinal”, “upper”, “lower”, “front”, “rear”, “back”, “left”, “right”, “top”, “bottom”, “inner”, and “outer”, etc., indicate the orientation or positional relationship based on the orientation or positional relationship shown in the accompanying drawings, and are only for the convenience of describing the application and simplifying the description, and do not indicate or imply that the device or element referred to must have a specific orientation, or be constructed and operated in a specific orientation, and therefore should not be construed as a limitation of the application. The terms “first” and “second” are used for descriptive purposes only and should not be construed as indicating or implying relative importance or implicitly specifying the number of indicated technical features. “A plurality” in this application refers to two or more.

In the description of the application, it should be noted that, unless otherwise explicitly specified and limited, the terms “installation”, “connect”, “connecting” and “connected” should be interpreted broadly. For example, they can refer to a fixed connection, a detachable connection, or an integral connection; they can refer to a direct connection or an indirect connection through an intermediate medium; and they can refer to the internal connection between two components. Those skilled in the art can understand the specific meaning of the above terms in the application based on the specific circumstances.

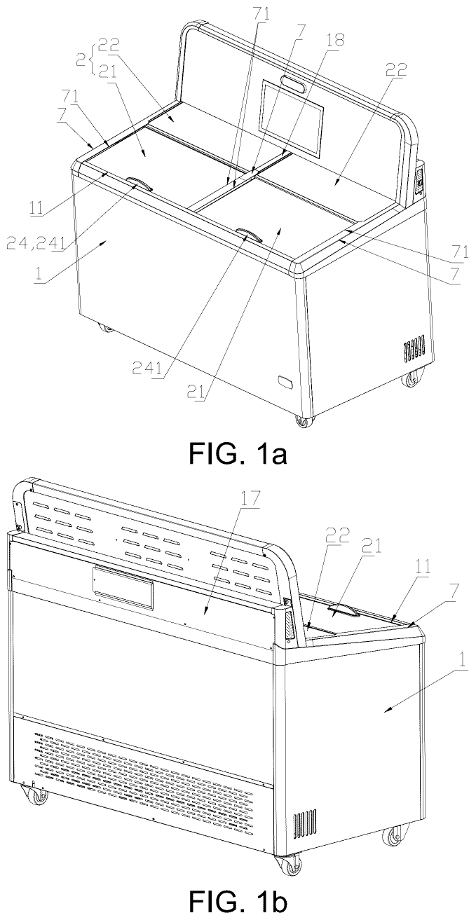

In an illustrative embodiment of a horizontal display freezer provided in the application, as shown in FIGS. 1a and 1b, the horizontal display freezer includes a freezer body 1, which has a freezer opening 11, and a door body 2 is mounted on the freezer opening 11. An accommodating chamber 12 is defined inside the freezer body 1 for containing goods that need to be refrigerated or frozen.

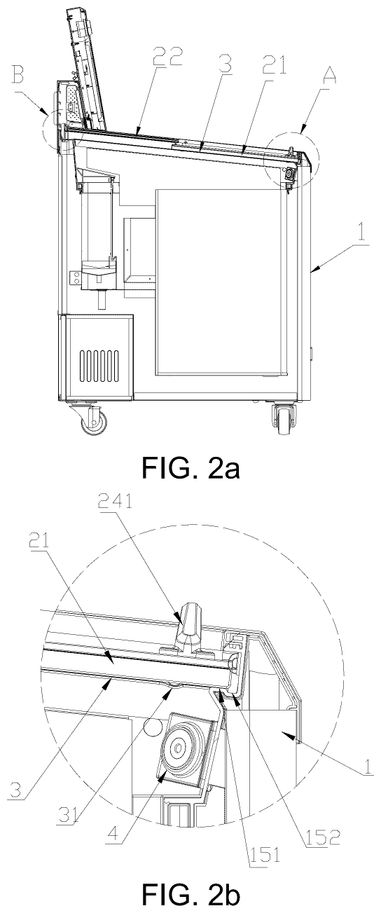

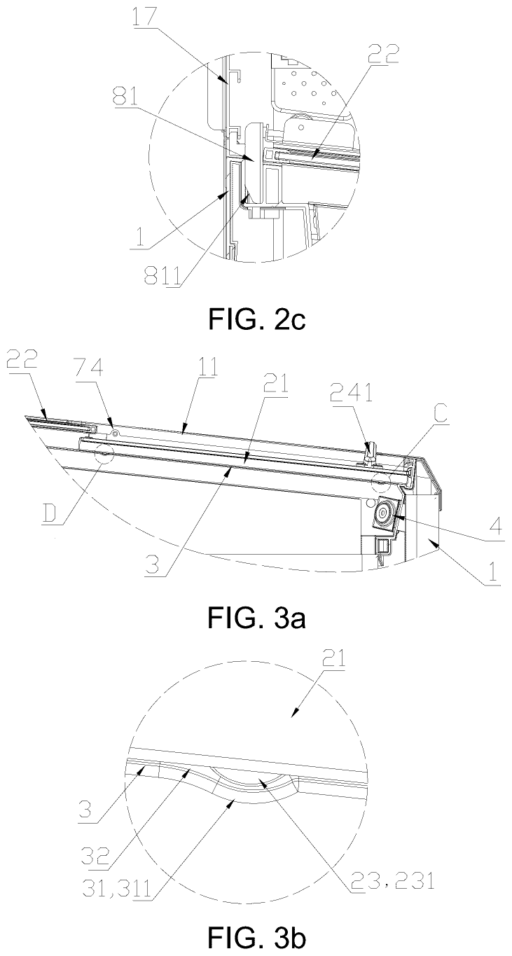

The door body 2 includes a front door 21 and a rear door 22. The rear door 22 is fixedly mounted at a rear end of the freezer opening 11, and the front door 21 is slidably mounted at a front end of the freezer opening 11. As shown in FIG. 2a, a height of the front end of the freezer opening 11 is lower than a height of the rear end of the freezer opening 11, allowing the door body 2 to be inclined arranged, so that the front door 21 slides down under its own weight and closes the freezer opening.

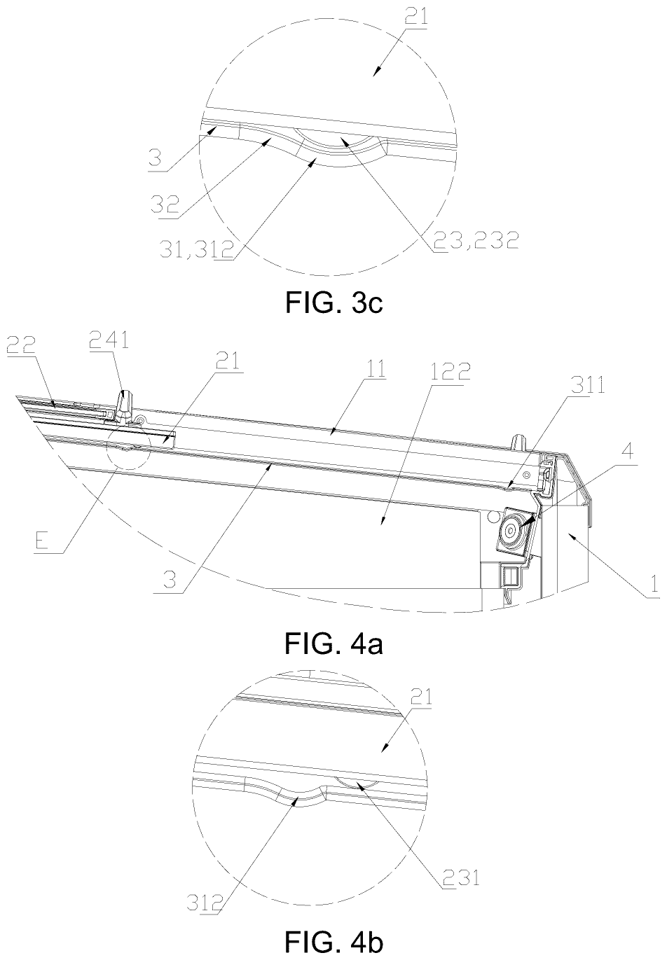

As shown in FIGS. 3a-4b, the freezer opening 11 is equipped with a guide rail 3, and the front door 21 has a guide wheel 23 that slides on the guide rail 3; the guide rail 3 has a positioning groove 31; when the front door 21 closes the freezer opening 11, the guide wheel 23 is located in the positioning groove 31, and a bottom surface of the front door 21 is in contact with a surface of the guide rail 3.

In the above embodiment, the freezer opening 11 is inclined arranged. The front door 21 is able to slide while the rear door 22 is fixed. When the freezer opening 11 is opened, the fixed rear door 22 keeps the rear side of the freezer opening 11 closed. The front door 21 can slide down under its own weight to a state to close the front side of the freezer opening 11. Therefore, after a customer takes goods and leaves, the freezer opening 11 can automatically close, avoiding heat loss and increased power consumption due to forgetting to close the door. This solves the problem of heat loss and increased energy consumption caused by forgetting to close the door in existing display freezer.

Furthermore, by sliding the guide wheel 23 on the guide rail 3 set on the freezer opening 11, the front door 21 can be slidably installed at the front side of the freezer opening 11, which reduces the resistance to the sliding of the front door 21 and prevents it from suspending due to excessive resistance during the downward sliding. Combined with the inclined design of the freezer opening 11, the front door 21 can slide down under its own weight until the front side of the freezer opening 11 is closed, ensuring the automatic closing effect of the door body 2. When the front door 21 closes the freezer opening, the guide wheel 23 is located in the positioning groove 31, which not only ensures that the front door 21 is closed in place, but also ensures that the bottom surface of the front door fits against the surface of the guide rail 3 when the front door is closed, so that there is no gap between the front door 21 and the guide rail 3, further increasing the sealing performance of the front door 21 to the freezer opening 11, thereby enhancing the heat preservation performance of the display freezer.

In some embodiments, as shown in FIGS. 3b and 3c, a rear side of the positioning groove 31 is connected with the surface of the guide rail 3 via an arc surface 32; when the front door 21 slides forward and closes the freezer opening 11, the guide wheel 23, sliding along the guide rail 3, gradually descends along the arc surface 32 into the positioning groove 31; the descent is relatively smooth, avoiding sudden large drops during the sliding process and preventing collisions when the guide wheel 23 falls into the positioning groove 31. Furthermore, when the front door 21 is pushed backward to open the freezer opening 11, the guide wheel 23 disengages from the positioning groove 31 along the arc surface 32, preventing the positioning groove 31 from jamming the guide wheel 23 and allowing the front door 21 to open smoothly.

In some embodiments, further referring to FIGS. 3a-4b, the positioning groove 31 includes a first positioning groove 311 located at a front end of the guide rail 3 and a second positioning groove 312 located behind the first positioning groove 311; the guide wheel 23 includes a first guide wheel 231 located at a front end of the front door 21 and a second guide wheel 232 located at a rear end of the front door 21. When the front door 21 closes the freezer opening 11, the first guide wheel 231 slides on the guide rail 3 between the first positioning groove 311 and the second positioning groove 312. Optionally, the rear side of the first positioning groove 311 and the rear side of the second positioning groove 312 are connected with the surface of the guide rail 3 by the arc surfaces 32.

In the above embodiments, when the front door 21 is opened, the second guide wheel 232 slides behind the second positioning groove 312, while the first guide wheel 231 always slides on the guide rail 3 between the first positioning groove 311 and the second positioning groove 312, and will not fall into the second positioning groove 312. When the freezer opening 11 is partially or fully open, both guide wheels 23 are located on the guide rail 3 and do not fall into the positioning grooves 31, thus preventing the positioning groove 31 from obstructing the sliding of the guide wheels 23, allowing the front door 21 to slide smoothly under its own weight, and ensuring the automatic closing performance of the door body 2.

In some embodiments, as shown in FIGS. 1a-4b, a limiting device 24 is installed on the door body 2 to limit the opening degree of the front door 21 when the freezer opening 11 is opened by the front door 21, preventing the opening degree of the front door 21 from exceeding the maximum opening state. When the front door 21 is in the maximum opening state, the first guide wheel 231 is located in front of the second positioning groove 312. In other words, when the front door 21 is opened to any state, the first guide wheel 231 remains on the surface of the guide rail 3 between the first positioning groove 311 and the second positioning groove 312, and will not fall into the second positioning groove 312; and the second guide wheel 232 remains on the surface of the guide rail 3 behind the second positioning groove 312. When the external force that opens the front door 21 is released, both the front and rear guide wheels 23 can slide forward along the guide rail 3 under the weight of the front door 21 until the front door 21 closes the freezer opening 11; the first guide wheel 231 falls into the first positioning groove 311, and the second guide wheel 232 falls into the second positioning groove 312, ensuring that the front door 21 can automatically close the freezer opening 11 under weight.

In some embodiments, the limiting device 24 is a handle 241, which is installed on a top surface of the front door 21. A front end of the rear door 22 is overlapped above the front door 21; when the handle 241 contacts the front end of the rear door 22, the front door 21 is in its maximum opening state.

In the above embodiment, the freezer opening 11 is opened by moving the front door 21 backward, and the handle 241 moves backward accordingly until it touches the front end of the rear door 22. The rear door 22 prevents the front door 21 from moving further backward through the handle 241, thereby limiting the opening degree of the front door 21 to no more than the maximum opening state. The handle 241 not only allows customers to hold and push, thus facilitating the opening of the front door 21, but also serves as an embodiment of the limiting device 24, restricting the front door 21 to a position not exceeding the maximum opening state during the opening process, preventing the first guide wheel 231 at the front end of the front door 21 from falling into the second positioning groove 312 at the rear side, ensuring that the front door 21 can automatically slide down and close the freezer opening 11 when the external force leaves the front door 21. In addition, the handle 241 can also act as a counterweight for the front door 21, with gravity acting on the front door 21, which can accelerate the automatic closing of the front door 21. Optionally, the handle 241 is located at the front end of the front door 21, allowing a larger portion of the front door 21 to move backward below the rear door 22, thus opening the freezer opening 11 to a greater extent and increasing the convenience of retrieving goods.

In the above embodiments, when using the handle as the limiting device to limit the maximum opening state, it can be designed based on the sizes of the freezer opening and the door body, ensuring the handle functions as a limiting device. Those skilled in the art can design such a device according to different sizes and specifications of the horizontal display freezer; it will not be elaborated further.

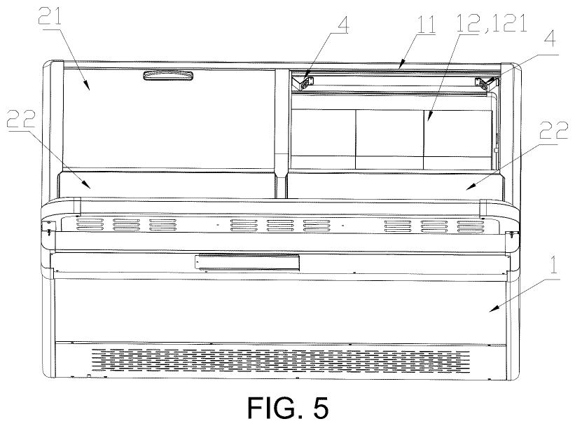

In some embodiments, as shown in FIG. 5, the horizontal display freezer further includes a camera 4, installed inside the freezer body 1 below the front door 21, to capture images of the goods inside the freezer body 1. This allows the horizontal display freezer to identify the type of goods retrieved through the captured video images under unmanned vending, enabling accurate goods payment.

Since the rear door 22 is fixed, only the front door 21 can be opened, ensuring that all goods are retrieved through the front side of the freezer opening 11. The camera 4, positioned below the front door 21, captures images that more comprehensively cover an area where goods are retrieved from the front side of the freezer body 1. Furthermore, since the front door 21 closes under its own weight, the user needs to hold the front door with one hand and reach into the freezer with another hand to retrieve the goods. Single-hand retrieval reduces arm obstruction of image capture, improving image recognition accuracy.

In some embodiments, further referring to FIG. 5, the accommodating chamber 12 is divided into multiple accommodating region 121. Each accommodating region 121 is equipped with two cameras 4, which are respectively mounted on the left and right sides of the front end of the corresponding accommodating region 121. This allows for overlapping image capture of the area below the front door 21, and the redundancy of the two camera images improves image recognition accuracy. Moreover, even if one camera 4 is obstructed by an arm, the other camera 4 can still capture images of the retrieved goods.

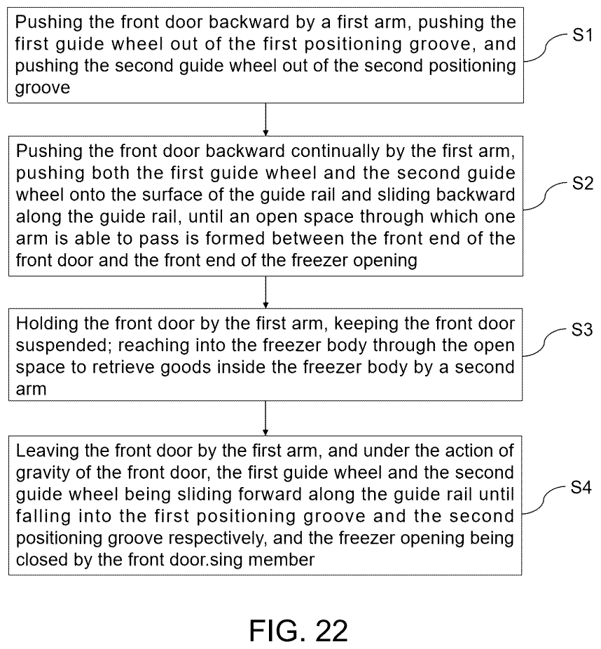

The present application further provides a use method of the above-mentioned horizontal display freezer, as shown in FIG. 22, including the following steps:
S1: in two arms of a user, pushing the front door 21 backward by a first arm, pushing the first guide wheel 231 out of the first positioning groove 311 and the second guide wheel 232 out of the second positioning groove 312, thereby eliminating the restriction on the front door 21;
S2: pushing the front door 21 backward continually by the first arm, pushing both the first guide wheel 231 and the second guide wheel 232 onto the surface of the guide rail 3, sliding backward along the guide rail 3, causing the front door 21 to slide backward; forming an open space 122 between the front end of the front door 21 and the freezer opening 11, connecting the interior and exterior of the freezer body 1; becoming wide gradually of the open space 122 until large enough for the user's arm to pass through as the front door 21 slides backward;
S3: holding the front door 21 by the first arm, keeping the front door 21 suspended; and keeping the open space 122 large enough for the arm to pass through; simultaneously, reaching into the freezer body 1 through the open space 122 to retrieve the goods inside by a second arm of the user;
S4: after retrieving the goods from the freezer body 1, releasing the front door 21 by the first arm of the user; that is, leaving the front door 21 by the first arm, and losing the support of the first arm for the front door 21; under the weight of the front door 21, the first guide wheel 231 and the second guide wheel 232 being sliding forward along the guide rail 3 until falling into the first positioning groove 311 and the second positioning groove 312 respectively, and the freezer opening 11 being closed by the front door 21.

When using the above horizontal display freezer, after the user opens the front door 21, if both arms of the user reach into the freezer body 1 to retrieve goods, the front door 21 will lose support and slide down under its weight, pressing down on the two arms and making it difficult to retrieve the goods out of the freezer body 1. To smoothly pull out the arms and retrieve the goods from the freezer body 1, the user needs to hold the front door 21 with one arm and reach into the freezer body 1 to retrieve the goods with the other arm.

Therefore, the front door 21 is able to slide down and close the freezer opening 11 under its own weight, which not only prevents the user from forgetting to close the door body 2 after leaving, thus avoiding heat loss, but also allows the user to enter the freezer body 1 with single hand to retrieve goods. Furthermore, when the horizontal display freezer is used in unmanned vending, a camera needs to be installed inside the freezer body 1, which captures images inside the freezer body 1, perform image recognition on the retrieved goods and accurately process the goods payment; the horizontal display freezer allows a user to enter the freezer 1 with single arm to retrieve goods; compared to entering the freezer body 1 with both arms, the single arm obstructs the camera less, thus improving the accuracy of camera image recognition.

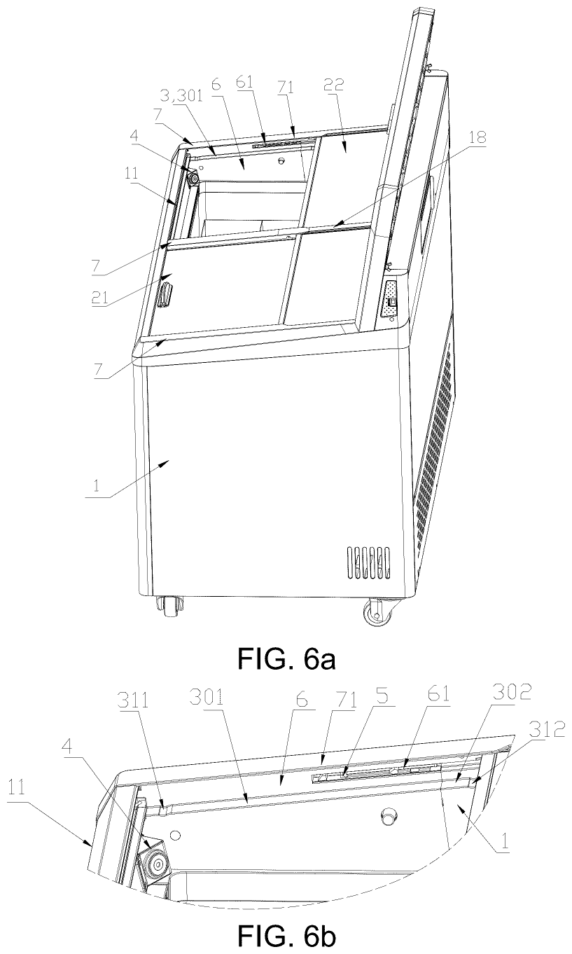

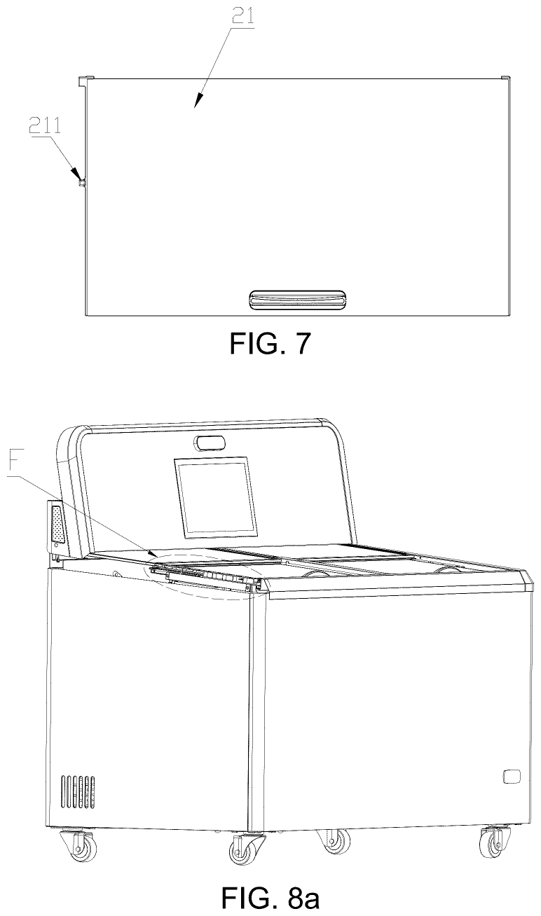

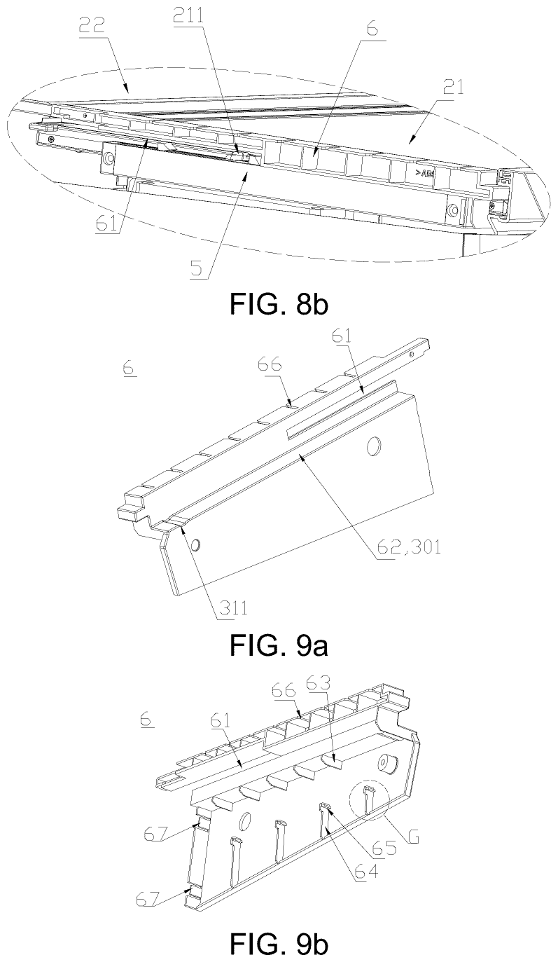

In some embodiments, as shown in FIGS. 6a-8b, a power buffering device 5 is installed on the freezer body 1, and at least one protrusion portion 211 is provided on the front door 21; the protrusion portion 211 protrudes towards the buffering device 5 and is connected to the buffering device 5 within a communication groove 61. During the sliding of the front door 21, the protrusion portion 211 moves within the communication groove 61 and, under the action of the buffering device 5, drives the front door 21 to slowly move from the rear end of the freezer opening 11 to the front end, achieving the slow closing of the front door 21. The buffering device 5 can utilize existing components with buffering effects; for example, the automatic door closing buffering device disclosed in CN213710775U can be referenced, and will not be elaborated here.

As shown in FIGS. 6a and 6b, a shell 6 is installed at the freezer opening 11, covering the buffering device 5, protecting the buffering device 5 from being impact and being directly exposed to moisture inside the freezer body 1, thereby reducing corrosion, lowering the risk of frost formation, extending service life, reducing the risk of jamming due to frost and remaining normal working condition for the buffering device 5.

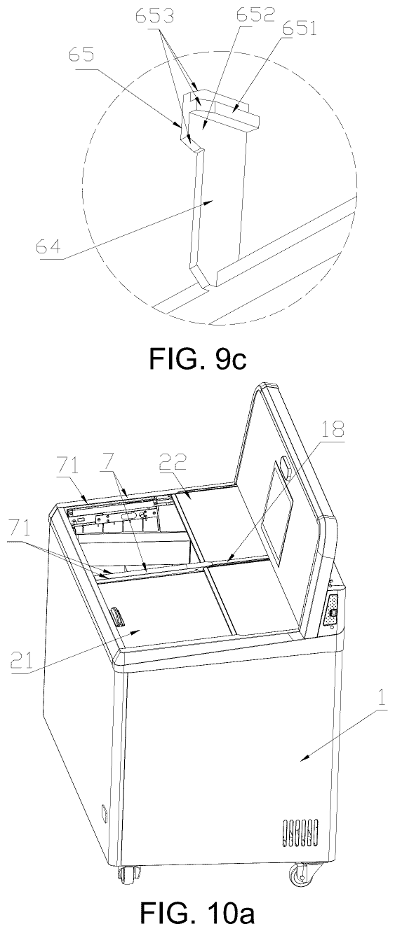

Further referring to FIGS. 9a and 9b, the shell 6 has the communication groove 61; when the front door 21 moves and when the protrusion portion 211 slowly closes the door body 2, the protrusion portion 211 moves in the communication groove 61 and slides slowly under the action of the buffering device 5. The communication groove 61 provides movement space for the protrusion portion 211.

In the above illustrative embodiment, the buffering device 5 is covered by the shell 6 to prevent it from being bumped or damaged, avoiding accelerated corrosion and surface frost caused by direct contact with moisture, preventing it from getting stuck, enabling stable operation for a long time, and improving its service life; the communication groove 61 provided by the shell 6 provides movement space for the protrusion portion 211, ensuring that the buffering device 5 buffers the closing of the front door 21 through the protrusion portion 211, solving the problems of easy bumping, corrosion, and jamming of the buffering device equipped in prior display freezers.

As shown in FIGS. 6b and 8a-9b, an opening of the communication groove 61 opens towards the rear side of the freezer opening. When the front door 21 moves from the rear end of the freezer opening 11 to the front end thereof, the protrusion portion 211 enters the communication groove 61 through the opening. During the front door 21 moves and closes the freezer opening 11, the buffering device 5 mainly buffers the front door 21 at the travel end of the door; when the front door 21 reaches the travel end, the protrusion portion 211 enters the communication groove 61 through the opening, thus interacting with the buffering device 5 to create a buffering effect. When the front door 21 opens, the protrusion portion 211 can leave the communication groove 61 through the opening, without limiting the open degree of the front door.

In some embodiments, as shown in FIG. 6b, the guide rail 3 includes a first rail segment 301 arranged on the shell 6 and a second rail segment 302 disposed on an inner wall of the freezer body 1; that is, a portion of the guide rail 3 is disposed on the shell 6, and another portion is disposed on the freezer body 1. The shell 6 and the inner wall of the freezer body are aligned on the sliding path of the front door 21. As part of the guide rail 3, the shell 6 guides the front door 21 to move smoothly, avoiding any obstruction to the movement of the front door 21. In the embodiment, the first positioning groove 311 is located on the first rail segment 301, and the second positioning groove 312 is located on the second rail segment 302.

In some embodiments, as shown in FIGS. 9a and 9b, a lower part of the shell 6 protrudes towards the accommodating chamber 12, forming a support table 62 on a top of the protruding part; and a top surface of the support table 62 serves as the first rail segment 301. An outer side of the support table 62, away from the accommodating chamber 12, has a first reinforcing rib 63, located below the first rail segment 301, not only reinforcing the support table 62 and enhancing its structural strength, but also strengthening the support for the first rail segment 301, improving its stability, preventing deformation under pressure during the sliding of the front door 21, and ensuring smooth opening and closing of the front door 21.

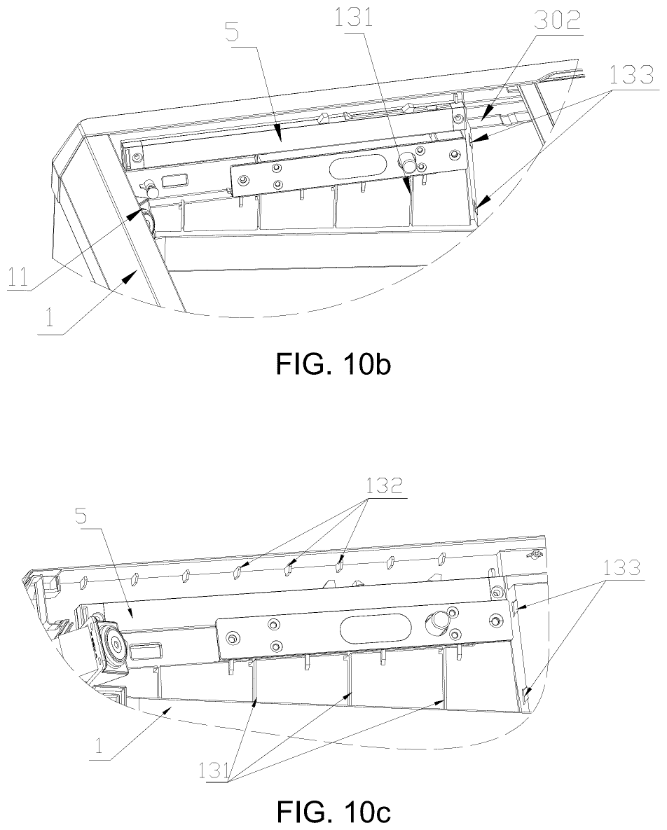

In some embodiments, as shown in FIGS. 9b, 9c, and 10a-10c, the shell 6 is provided with multiple first plug-in plates 64, and the inner wall of the freezer body 1 is provided with multiple first sockets 131 correspondingly; the shape of each first socket 131 matches with the shape of each first plug-in plate 64 for insertion, thereby fixing the shell 6 to the freezer body 1 by insertion, facilitating installation. Specifically, the first plug-in plates 64 are located at the lower part of the outer surface of the shell 6.

In some embodiments, further referring to FIGS. 9b and 9c, the first plug-in plate 64 is provided with a limiting portion 65, which has a first limiting plate 651 transversely arranged and a second limiting plate 652 vertically arranged, intersected with each other. In this embodiment, the first plug-in plate 64 is vertically arranged, and the limiting portion 65 is located at the top of the first plug-in plate 64. Since the shape of the first socket 131 matches with that of the first plug-in plate 64, the limiting portion 65 with cross structure cooperates with the first socket 64 to achieve a limiting effect. Specifically, the first socket 64 has the shape that matches the first plug-in plate 64 and the limiting portion 65 thereon; the transverse first limiting plate 651 can restrict the shell 6 from moving vertically, and the vertical second limiting plate 652 can restrict the shell 6 from moving transversely, thereby improving the stability of the shell 6 after insertion and enhancing the firmness of the shell 6 installation.

In some embodiments, further referring to FIG. 9c, each of a side of the first limiting plate 651 towards the first socket 131 and a side of the second limiting plate 652 towards the first socket 131 has a chamfer 653 respectively, making an end of the limiting portion 65 near the first socket 131 has a constricted structure. Guided by beveled surfaces of the chamfers 653, the limiting portion 65 is more easily inserted into the first socket 131.

In some embodiments, as shown in FIGS. 9a-10c, the shell 6 has multiple second sockets 66, and the inner wall of the freezer body 1 is provided with multiple second plug-in plates 132 correspondingly, being able to insert into the second sockets 66. Specifically, the second sockets 66 are located at a top of the shell 6, and the second plug-in plates 132 are located adjacent to the top of the freezer opening 11. The top of the shell 6 is connected to the freezer body 1 via the second sockets 66 and the second plug-in plates 132, and the lower part of the shell 6 is connected to the freezer body 1 via the first plug-in plates 64 and the first sockets 131. The freezer body 1 and the shell 6 are inserted into each other, thereby improving the firmness of the connection therebetween.

In some embodiments, as shown in FIGS. 9b and 10c, the shell 6 has at least one vertically arranged clamping plate 67, which engages in a slot 133 opened on the inner wall of the freezer body 1. Specifically, the clamping plate 67 is located on one or both sides of the shell 6 in the transverse direction, extending towards the inner wall of the freezer body 1 and clamping into the slot 133 provided on the inner wall of the freezer body 1, thereby improving the firmness of the shell 6 installation. Furthermore, the clamping plate 67 can be directly inserted into the slot 133 during installation and can be pulled out of the slot 133 under external force during removal, making the installation and removal of the shell 6 convenient, and allowing for quick removal of the shell 6 for repair or replacement in case of a malfunction in the buffering device 5.

The lower part of the shell 6 is inserted and fixed to the freezer body 1 via the first plug-in plates 64 and the first sockets 131; the top thereof is inserted and fixed to the freezer body 1 via the second plug-in plates 132 and the second sockets 66; the side thereof is clipped to the freezer body 1 via the clamping plate 67 and the slot 133, thus achieving the installation and fixation of different parts of the shell 6, ensuring that the shell 6 is securely installed on the freezer body.

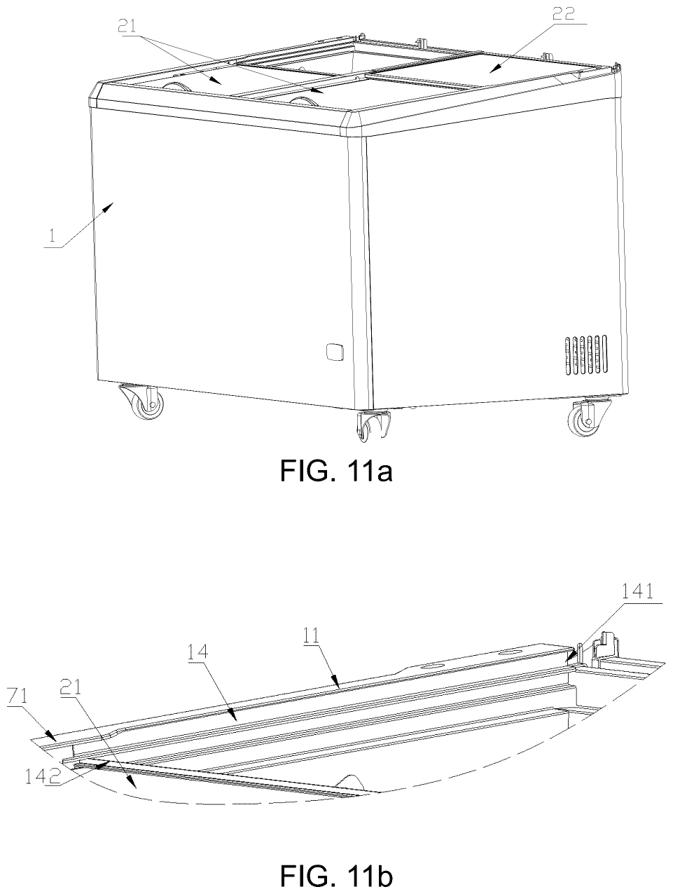

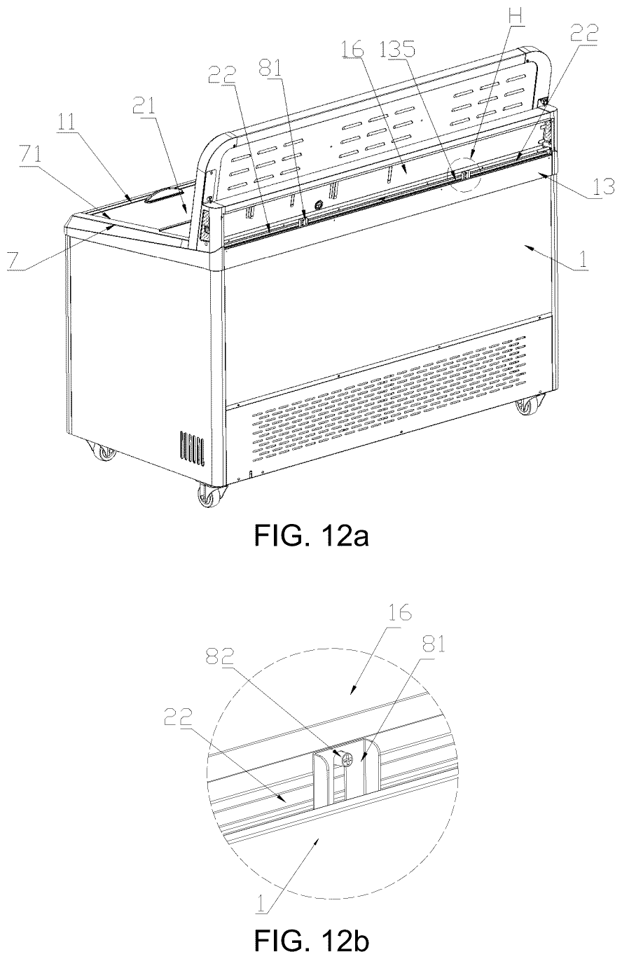

In some embodiments, as shown in FIG. 2a, the front end of the rear door 22 is overlapped above the rear end of the front door 21; that is, the front end of the rear door 22 is located above the rear end of the front door 21. Referring further to FIGS. 11a and 11b, a mounting groove 14 is provided on each left and right sides of the freezer opening 11. The rear end of the mounting groove 14 extends to the rear side of the freezer body 1 and has an opening end 141; both sides of the rear door 22 are inserted into the corresponding mounting grooves 14 through the corresponding opening ends 141. An edge-pressing strip 7 is installed on the left and right sides of the freezer opening 11 respectively. Each edge-pressing strip 7 has a covering portion 71 extending above the front door 21, to prevent the front door 21 from detaching upwards from the freezer opening 11. The edge-pressing strips 7 can be fixedly installed on the freezer opening 11 or integrally formed on the freezer body 1. It is understood that, to achieve the insertion of the rear door 22, an opening of each mounting groove 14 faces the accommodating chamber 12.

The rear door 22 is stacked on the rear end of the front door 21, and the covering portion 71 of the edge-pressing strip 7 is above the front door 21, so that the rear door 22 and the edge-pressing strip 7 respectively restrict the rear end and front of the front door 21 from moving upward. The guide rail 3 arranged on the rear door 22 and the freezer opening 11 restricts the rear end of the front door 21 from up and down; the guide rail 3 arranged on the edge-pressing strip 7 and the freezer opening 11 restricts the front end of the front door 21 from up and down. The rear door 22 and the guide rail 3 form a guide groove at the rear of the freezer body, guiding the front door 21. This makes the front door slide only along its plane, unable to move or rotate vertically, so the front door cannot be lifted up to detach from the freezer opening 11, nor can it be removed from the freezer opening 11 by lifting the front part of the front door 21 above the freezer opening 11 and pulling it forward, which makes it difficult for the front door 21 to be easily removed from the freezer opening 11. The rear door 22 is fixed and cannot be easily removed either. Thus, the door body 2 has strong anti-dismantling performance, enhancing the anti-theft performance. By simply locking the sliding of the front door 21, the door body 2 can reliably seal the freezer opening 11, preventing the theft of goods inside the display freezer.

By setting the mounting groove 14, the rear door 22 is fixed to the freezer opening 11 in a rear-to-front insertion manner. The rear door 22 is fixedly installed by clamping the rear door 22 with the mounting groove 14, or by a limiting structure preventing it from detaching, which makes installation convenient. Furthermore, as the door body 2 is tilted along the freezer opening 11, the mounting groove 14 is also tilted; the rear door 22 pushes forward under gravity, pressing it tightly against the front end of the mounting groove 14, thus ensuring the stability of the rear door 22 therein. After the rear door 22 is installed and fixed, the mounting groove 14 is embedded at the freezer opening 11, making it difficult to disassemble or damage, thus enhancing the anti-theft and anti-damage function of the rear door 22. Furthermore, a U-shaped gap is formed between the mounting groove 14 and an edge of the rear door 22. The gap is tortuous, which enhances sealing performance, improves insulation, and also improves the waterproofing of the left and right edges of the rear door 22; condensate can only flow forward on the inclined rear door 22, preventing it from entering into the freezer body 1 through gaps between the rear door 22 and the freezer opening 11.

As the door body 2 is inclined, the condensate forming on the surface of the front door 21 flows forward, leaves from its front edge and is drained into a drainage structure at the freezer opening 11. As the front end of the rear door 22 overlaps the rear end of the front door 21, condensate forming on the surface of the rear door 22 also flows forward, leaves from its front edge and falls onto the front door 21 below, further flows forward along the front door 21, leaves and is drained into the drainage structure at the freezer opening 11. During the condensate flows from rear to front, it passes over a gap between the rear door 22 and the front door 21; the inclined front door 21 also prevents the condensate from flowing backward into the gap therebetween, thus avoiding condensate accumulation at the gap and preventing it from seeping into the freezer body 1 and causing freezing.

In some embodiments, as shown in FIG. 2b, a water-blocking table 151 is formed at the front side of the freezer opening 11. The front end of the front door 21 is located above the water-blocking table 151, allowing the condensate to flow forward and fall onto the water-blocking table 151 after leaving the front door 21. A drainage groove 152 is provided at a front side of the water-blocking table 151, connecting to a drainage hole (not shown in the FIG.) in the freezer body 1. Since a gap between the front door 21 and the freezer opening 11 is located above the front side of the water-blocking table 151, the condensate falling into the gap falls into the drainage groove 152 on the water-blocking table 151, and then flows along the drainage groove 152 to the drainage hole and is discharged outside the freezer body 1.

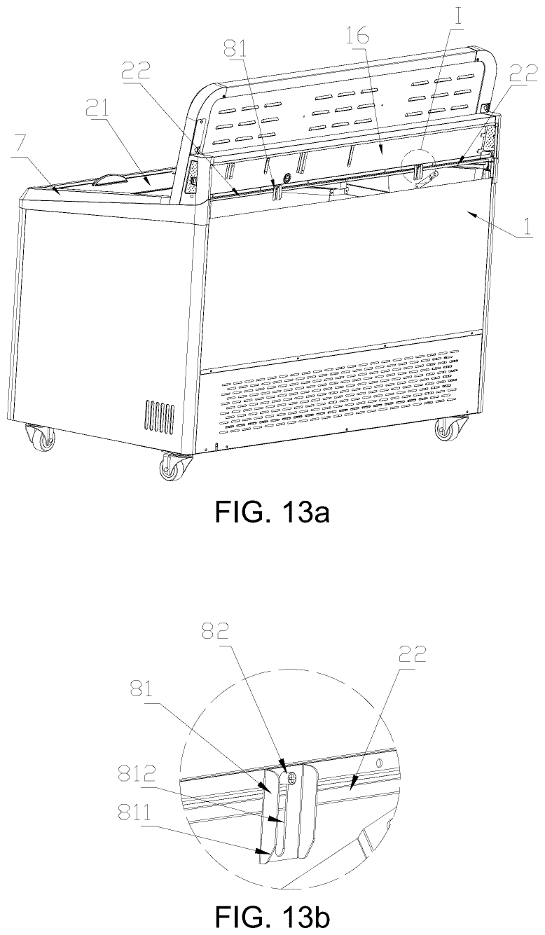

In some embodiments, as shown in FIGS. 2c and 12a-13b, a limiting block 81 is installed in a space 135 between a back part 13 of the freezer body and the rear door 22. The back part 13 of the freezer body presses against the limiting block 81, and the limiting block 81 presses against the rear end of the rear door 22, further presses the front end of the rear door 22 against an inner wall 142 of an front end of the mounting groove 14. The limiting block 81 presses against the rear door 22 at the back part 13 of the freezer body, which not only prevents rear door 22 from slipping out of the mounting groove 14 backward and maintains its fixed installation, but also tightly presses the front end of the rear door 22 against the inner wall 142 of the front end of the mounting groove 14, ensuring close contact and improving the sealing performance between the front end of the rear door 22 with the freezer opening 11.

The rear door 22 and the back part 13 of the freezer body forms a clamping for the limiting block 81, so that a space 135 between the rear door 22 and the back part 13 of the freezer body is in an interference fit state with the limiting block 81. A bottom of a rear side of the limiting block 81 has a wedge 811, so that a thickness of the bottom of the limiting block 81 gradually decreases from top to bottom, allowing the limiting block 81 to insert downwards into the space 135 between the rear door 22 and the back part 13 of the freezer body and achieve an interference fit therebetween. Also, the wedge 811 can be positioned at a top of the rear side of the limiting block 81, in which case the limiting block 81 inserts upwards into the space 135 between the rear door 22 and the back part 13 of the freezer body and achieves an interference fit.

The limiting block 81 is mounted on the freezer body 1 by a fastening bolt 82. The limiting block 81 has a vertically arranged waist hole 812, through which the fastening bolt 82 passes. After loosening the fastening bolt 82, the limiting block 81 is able to be raised and lowered by the cooperation of the fastening bolt 82 and the waist hole 812, leaving the rear end of the rear door 22 and enabling the rear door 22 to be pulled out and removed. During installation of the rear door 22, the raised or lowered limiting block 81 will not obstruct the insertion of the rear door 22. After the rear door 22 is fully inserted into the mounting groove 14, the limiting block 81 is raised or lowered to align with the rear end of the rear door 22; tightening the fastening bolt 82 will then press the limiting block 81 firmly onto the rear door 22. If the rear door 22 is damaged and needs replacement, the old door is removed first, and then a new door is installed; throughout the process, the limiting block 81 remains suspended on the fastening bolt 82 and does not need to be removed, making the operation convenient.

In some embodiments, as shown in FIG. 12a, an assembly window 16 is opened at the rear side of the freezer body 1. The opening end 141 of the mounting groove 14 is exposed through the assembly window 16, allowing the opening end 141 to communicate with an outside of the freezer body. When the rear door 22 is inserted into or removed from the mounting groove 14 via the opening end 141, the rear door 22 must pass through the assembly window 16; thus the assembly window 16 serves as a necessary passage for the installation and removal of the rear door 22. A cover plate 17 is installed on the assembly window 16, closing the assembly window 16 and thus enclosing the opening end 141 of the mounting groove 14 and the limiting block 81 inside the freezer body 1, which increases the disassembly steps of the rear door 22, improves the anti-theft and anti-disassembly effect of the door body 2.

When the limiting block 81 has the waist hole 812 and the freezer body 1 is provided with the assembly window 16, loosening the fastening bolt 82 allows the limiting block 81 to be raised or lowered in the assembly window 16; which not only removes the limiting block 81 from the rear door 22 but also allows the limiting block 81 to be pulled out of the space 135. After the rear door 22 is installed, the limiting block 81 is inserted into the space 135, securing both the limiting block 81 and the rear door 22; tightening the fastening bolt 82 at this point is easy. The assembly window 16 not only facilitates the installation and removal of the rear door 22 but also provides operating space for the limiting block 81 to be inserted and removed, further improving the convenience of installation and removal operations.

In some embodiments, a partition 18 installed on the freezer body 1 divides the freezer opening 11 into multiple ones. Each divided freezer opening 11 is equipped with the door body 2; that is, each divided freezer opening 11 is sealed by a fixed rear door 22 and a sliding front door 21. The edge-pressing strip 7 is installed on the partition 18; that is, each divided freezer opening 11 has edge-pressing strips 7 on both sides. In this case, the partition 18 serves as a part of the freezer opening 11, relevant components or structures described in the application for installing or cooperating with the door body are formed on the partition 18 as needed; reference can be made to other embodiments, and details are not to be repeated here.

The multiple freezer openings 11 can be opened and closed simultaneously, improving the efficiency of retrieving goods. Simultaneously, the front end of the rear door 22 overlaps the rear end of the front door 21, ensuring that no condensation seeps into the door gaps of each freezer opening 11. Additionally, the edge-pressing strip 7 is located on the partition 18, front doors are mounted on both leaf and right sides of the partition 18, thus the covering portion 71 is arranged on both left and right sides of the partition 18, which limits the movement of the corresponding front doors 21, ensuring that both front doors 21 have anti-disassembly capabilities.

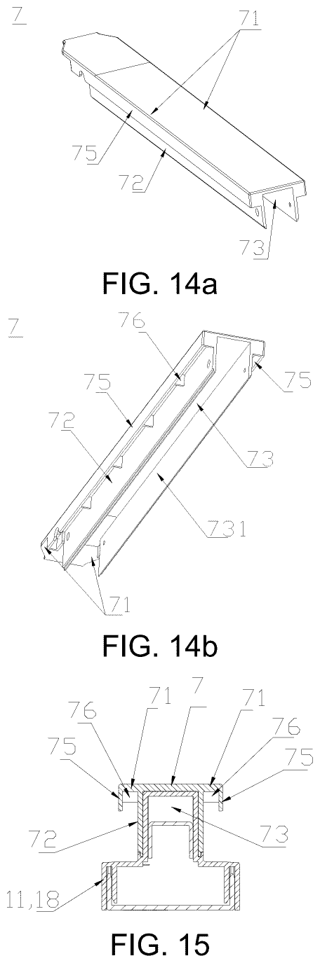

In some embodiments, a structure of the edge-pressing strip 7 on the partition 18 is provided; the edge-pressing strips installed on both sides of the freezer body can also refer to the structure, with the difference that a covering portion is formed only on the side above the front door. As shown in FIGS. 14a-15, a bottom surface of the edge-pressing strip 7 has a downwardly protruding mounting portion 72, and the mounting portion 72 has an assembly groove 73. The edge-pressing strip 7 can be pressed onto the freezer opening 11 (i.e., the partition 18), and the freezer opening 11 (i.e., the partition 18) is inserted into the assembly groove 73. The insertion and engagement of the partition 18 with the assembly groove 73 facilitates the installation of the edge-pressing strip 7 and allows for its positioning. This ensures that the covering portion 71 is positioned above the front door after installation, thereby guaranteeing the limiting effect of the cover 71 on the front door 21. The following description of the freezer opening 11 includes the partition 18 as a part of the freezer opening 11.

In some embodiments, the edge-pressing strip 7 is fixed to the freezer opening 11 by a fixing bolt 74. The fixing bolt 74 passes through into the assembly groove 73 from one side of the edge-pressing strip 7 and is fixedly connected to the freezer opening 11. The fixing bolt 74 is inserted from the side direction of the edge-pressing strip 7, so that a head of the fixing bolt 74 can only be exposed through a gap between the covering portion 71 and the front door 21, or is blocked by the front door 21. When the front door 21 is not opened, it is difficult or impossible to remove the fixing bolt 74 through narrow space with a screwdriver, thus ensuring that the fixing bolt 74 firmly fixes the edge-pressing strip 7 to the freezer opening 11, improving the anti-disassembly performance of the edge-pressing strip 7, thereby ensuring the anti-disassembly performance of the front door 21 and enhancing the anti-theft performance.

In some embodiments, there are multiple fixing bolts 74. An upper surface of the freezer opening 11 abuts against an inner wall 731 of the assembly groove 73; when the front door 21 is closed, at least one fixing bolt 74 is aligned transversely with the front door 21, so that the front door 21 covers at least one fixing bolt 74 from the side direction.

At Least one fixing bolt 74 is blocked by the front door, and the blocked fixing bolt 74 cannot be removed, thus maintaining the limit to the edge-pressing strip 7 and preventing it from moving on its plane; furthermore, as the upper surface of the freezer opening 11 is closely contacted with the inner wall 731 of the assembly groove 73, the cooperation therebetween prevents the edge-pressing strip 7 from angularly deflecting relative to the upper surface of the freezer opening 11, thereby preventing the edge-pressing strip 7 warping from the freezer opening 11. By fitting the edge-pressing strip 7 against the freezer opening 11 and fixing it at least at one point with the fixing bolt 74, the edge-pressing strip 7 can be firmly fixed to the freezer opening 11, thereby making the edge-pressing strip 7 anti-disassembly, ensuring the limiting of the covering portion 71 to the front door 21, and ultimately maintaining the anti-disassembly performance of the front door 21 and enhancing the anti-theft performance.

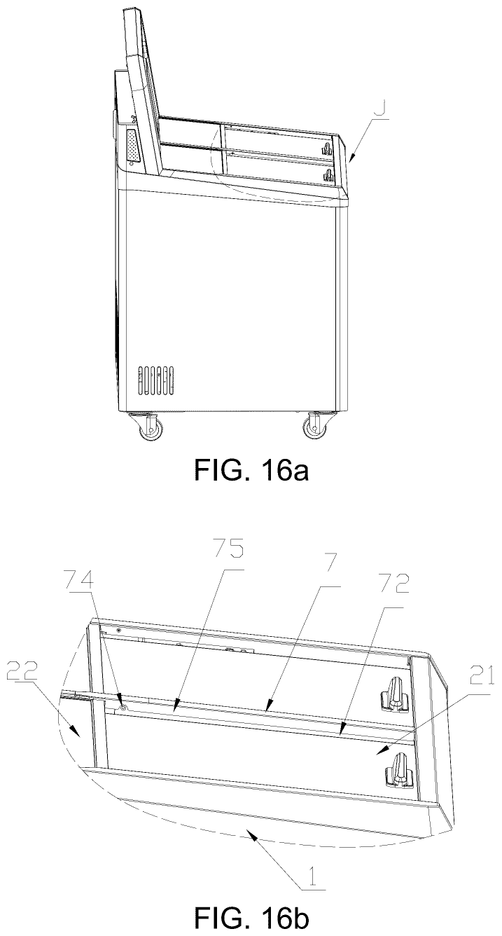

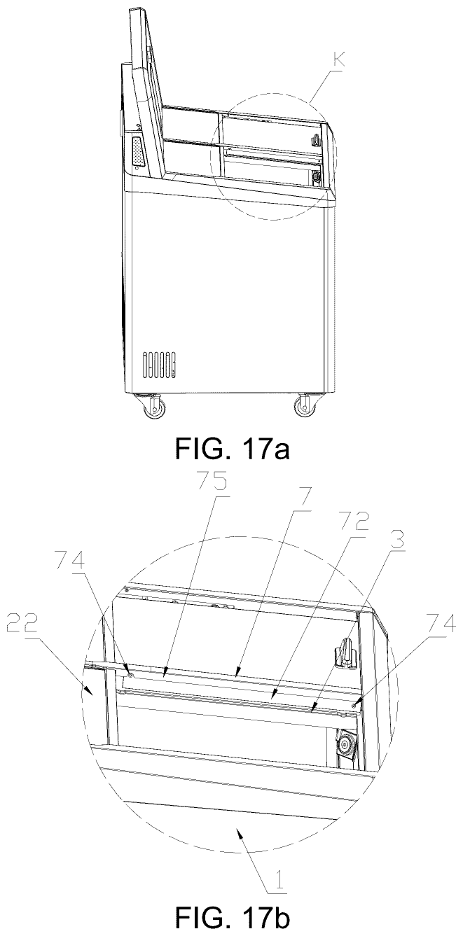

FIG. 16a is a schematic diagram of the front door 21 in the closed state, and FIG. 16b is a partial enlarged view of the position of the edge-pressing strip 7 installed on the partition 18 in FIG. 16a, illustrating the state of the fixing bolts 74 when the front door 21 is closed. FIG. 17a is a schematic diagram of the front door 21 at one side in the open state. FIG. 17b is a partial enlarged view of the position of the edge press strip installed on the partition 18 in FIG. 17a, illustrating the state of the fixing bolts 74 when the front door 21 is open.

In the embodiments shown in FIGS. 16a-17b, the fixing bolts 74 are located at the front and rear ends of the edge-pressing strip 7. When the front door 21 closes the freezer opening 11, the fixing bolt 74 at the front end of the edge-pressing strip 7 are aligned transversely with the front door 21, and is blocked by the front door, making it impossible to remove; the edge-pressing strip 7 maintains its anti-disassembly properties and is firmly fixed to the freezer opening 11. The fixing bolt 74 at the rear end of the edge-pressing strip 7 is located above the front door 21, thus keeping the fixing bolt further away from the interior of the freezer body 1, reducing the impact of bolt hole on the structure of the freezer body 1, and ensuring the insulation performance of the freezer body 1. The fixing bolt 74 located above the front door 21 can also be installed when the front door 21 is closed, enhancing the convenience of installation without affecting the anti-disassembly properties of the edge-pressing strip 7. The fixing bolts 74 at both ends of the edge-pressing strip 7 are staggered up and down, increasing the coverage area of the fixing points of the edge-pressing strip 7 and further improving the firmness thereof.

In some embodiments, as shown in FIGS. 14a-15, a downwardly extending guard plate 75 is provided at two sides of a top surface of the edge-pressing strip 7 respectively. The guard plate 75 is located at an outer side the mounting portion 72, serving as a part of the covering portion 71. A bottom end of the guard plate 75 is in slidable contact with the top surface of the front door 21, thereby causing the covering portion 71 in slidable contact with the top surface of the front door 21; thus further enhancing the limiting effect of the covering portion 71 to the front door 21, making it difficult for the front door 21 to be easily removed from the freezer opening 11, and enhancing the anti-theft performance of the door body 2.

Furthermore, since the guard plate 75 located above the front door 21, it not only blocks the fixing bolts 74 from the side direction but also makes it difficult for hands to reach under the edge-pressing strip 7, which further increases the difficulty of disassembling the fixing bolts 74 when the front door 21 is closed and also increases the difficulty of manually pulling the edge-pressing strip 7, thus increasing the anti-disassembly properties of the edge-pressing strip 7. Second reinforcing ribs 76 are installed between the guard plate 75 and the mounting portion 72; multiple second reinforcing ribs 76 are arranged from front to rear, thereby improving the stability of the guard plate 75 and the overall structural strength of the edge-pressing strip 7, preventing deformation of the edge-pressing strip 7 and enhancing anti-disassembly performance.

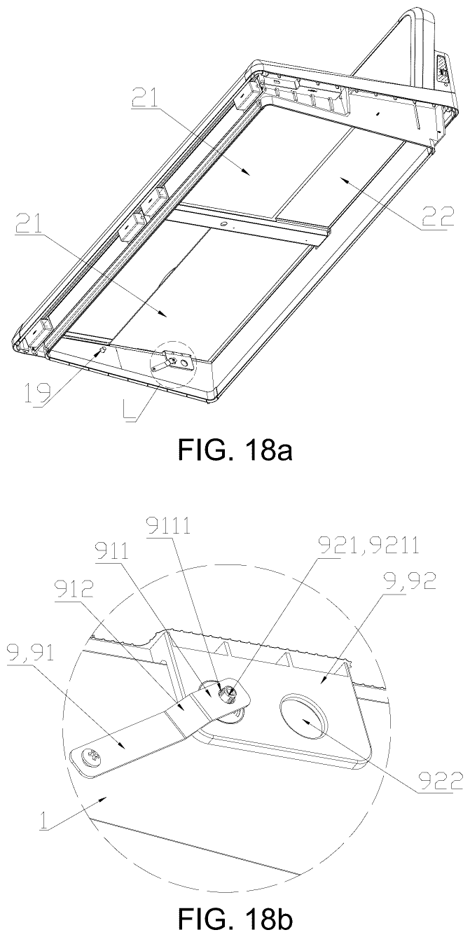

In some embodiments, the horizontal display freezer further includes a locking structure 9 of the door body. As shown in FIGS. 18a-20b, the locking structure 9 includes a rotating member 91 and a locking member 92. A first end of the rotating member 91 at length direction thereof is rotatably connected to the inner wall of the freezer body 11, and a second end of the rotating member 91 at the length direction is provided with a first connecting portion 911. The locking member 92 is located inside the freezer body 11 and connected with the front door 21. The locking member 92 is arranged adjacent to the inner wall of the freezer body where the rotating member 91 is arranged. The locking member 92 moves synchronously with the front door 21, and the locking member 92 has a second connecting portion 921. The second connecting portion 921 cooperates with the first connecting portion 911 to prevent the movement of the locking member 92 and the front door 21, thus locking the front door 21 in the open state, as shown in FIG. 18a.

When it is needed to lock the front door 21 in the open state, the rotating member 91 is rotated so that the first connecting portion 911 approaches and connects with the second connecting portion 921 of locking member 92; this allows the rotating member 91 to constrain the front door through the locking member 92, preventing the front door 21 from moving downwards under gravity and thus preventing the front door 21 from closing the accommodating chamber 12. When it is needed to release the constraint, the first connecting portion 911 and the second connecting portion 921 are separated, and the rotating member 91 is rotated so that the first connecting portion 911 moves away from locking member 92. At this time, if no external force pushes the front door 21 backwards and upwards, the front door 21 will close the accommodating chamber 12 under gravity.

In some embodiments, as shown in FIGS. 18a-20b, the first connecting portion 911 is a connecting hole 9111, and the second connecting portion 921 is a connecting column 9211; the rotating member 91 and locking member 92 are connected with each other by inserting the connecting column 9211 in the connecting hole 9111.

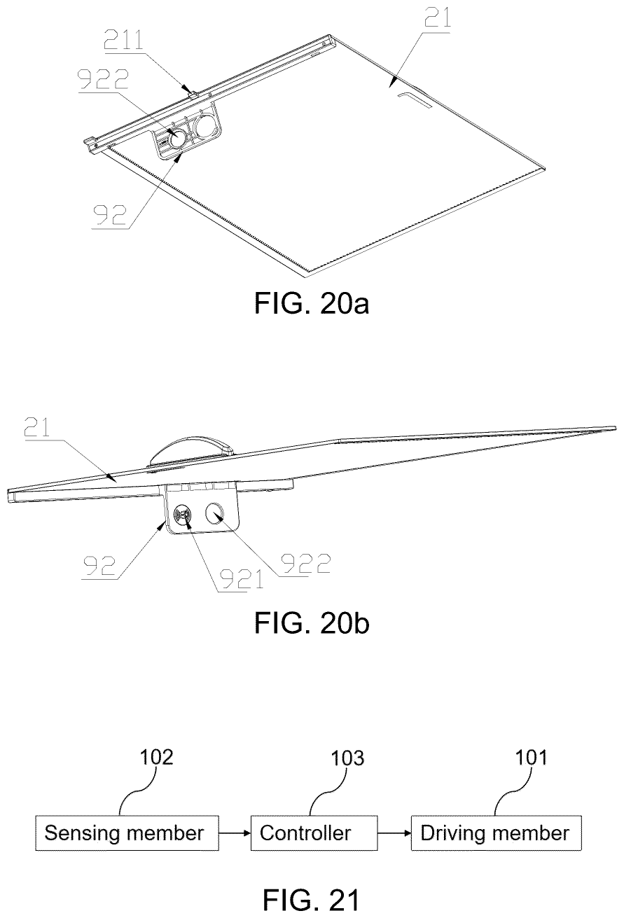

To facilitate the connection between the first and second connecting portion 911, 921, as shown in FIG. 20b, the second connecting portion 921 is located on a side of the locking member 92 away from the inner wall of the freezer body where the rotating member 91 is arranged; that is, the second connecting portion 921 is arranged towards the accommodating chamber 12, thereby facilitating the user to connect the first and second connecting portion 911, 921 within the accommodating chamber 12.

In some embodiments, as shown in FIG. 18b, the rotating member 91 has a bent portion 912 that bends away from the inner wall of the freezer body where the rotating member 91 is arranged. The bent portion 912 is located in a middle part of the rotating member 91, so that there is a distance between the second end of the rotating member 91 where the first connecting portion 911 is located and the inner wall of the freezer body where the rotating member 91 is arranged, preventing interference between the rotating member 91 and the locking member 92.

It is understood that the rotating member 91 can deform in a direction perpendicular to its length direction to facilitate the first connecting portion 911 fitting around the outer periphery of the second connecting portion 921. When the rotating member 91 constrains the locking member 92, an external force is used to bend the second end of the rotating member 91 away from the inner wall of the freezer body 11, creating a distance between that end and the inner wall; then, the front door 21 and the locking member 92 are moved to align the first connecting portion 911 with the second connecting portion 921; the external force is then removed, allowing the first connecting portion 911 to sleeve around the outer periphery of the second connecting portion 921.

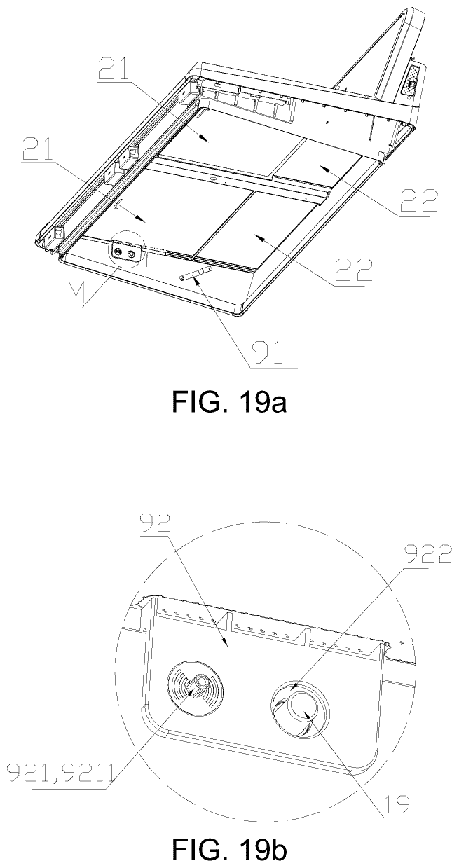

As shown in FIGS. 19a and 19b, the inner wall of the freezer body where the rotating member 91 is arranged is also provided with a limiting column 19. The limiting column 19 is arranged adjacent to the front end of the freezer body 11 and is able to extend and retract relative to the inner wall. The locking member 92 has a limiting hole 922; by inserting the limiting column 19 into the limiting hole 922, the front door 21 is locked in the closed state, as shown in FIG. 19a.

In some embodiments, the limiting hole 922 and the second connecting portion 921 are arranged side-by-side along the front-rear direction of the freezer body, and the limiting hole 922 is located at a rear side of the second connecting portion 921.

To prevent the limiting column 19 from affecting the movement of the front door 21, the limiting column 19 can extend and retract relative to the inner wall of the freezer body. During the movement of the front door 21, the limiting column 19 retracts to release the constraint on the front door 21; when the front door 21 is closed in place, the limiting column 19 extends to lock the front door 21.

Specifically, the freezer body is also equipped with a driving member 101 and a sensing member 102; the driving member 101 is able to drive the limiting column 19 to extend into or retract from the limiting hole 922; and the sensing member 102 is positioned adjacent to the movement trajectory of the locking member 92, to collect the position information of the locking member 92.

When the front door 21 needs to be locked in the closed state, the front door 21 takes the locking member 92 to move; when the sensing member 102 senses that the locking member 92 is close to the front end of the freezer body 11, the driving member 101 drives the limiting column 19 to retract according to the sensing information of the sensing member 102, so as to prevent the limiting column 19 from interfering with the movement of the locking member 92. When the front door 21 contacts the front end of the freezer body 11 or the locking member 92 moves to a designated position, the limiting column 19 is opposite to the limiting hole 922; the driving member 101 drives the limiting column 19 to extend into the limiting hole 922, so that the limiting column 19 constrains the front door 21 and locks the front door 21 in the closed state.

In the above embodiments, the driving member 101 and the sensing member 102 can be implemented using existing conventional devices; for example, the driving member 101 can adopt a motor or cylinder, and the sensing member 102 can adopt a sensor; and specific implementation manner can be implemented by those skilled in the art based on existing technology, and will not be elaborated here. In addition, to control the extension and retraction of the limiting column 19, a controller 103 is provided, which is connected with the sensing member 102 and the driving member 101, receiving the sensing information from the sensing member 102, and controls the driving member 101 to drive the limiting column 19 to extend or retract according to the sensing information, as shown in FIG. 21.

1. A horizontal display freezer, comprising a freezer body; the freezer body has a freezer opening, and a door body is mounted at the freezer opening; wherein,
the door body comprises a front door and a rear door, the rear door is fixedly mounted at a rear end of the freezer opening, and the front door is slidably mounted at a front end of the freezer opening; a height of the front end of the freezer opening is lower than a height of the rear end, so that the door body is inclined arranged, and the front door slides down and closes the freezer opening under an action of gravity;
the freezer opening is equipped with a guide rail, and the front door is provided with a guide wheel, being able to slide on the guide rail; the guide rail is provided with a positioning groove, and when the front door closes the freezer opening, the guide wheel is located in the positioning groove and a bottom surface of the front door is in contact with a surface of the guide rail.

2. The horizontal display freezer according to claim 1, wherein, the positioning groove comprises a first positioning groove located at a front end of the guide rail and a second positioning groove located at a rear side of the first positioning groove, and the guide wheel comprises a first guide wheel located at a front end of the front door and a second guide wheel located at a rear end of the front door; when the front door closes the freezer opening, the first guide wheel is located in the first positioning groove, and the second guide wheel is located in the second positioning groove; when the front door opens the freezer opening, the first guide wheel slides on the guide rail between the first positioning groove and the second positioning groove.

3. The horizontal display freezer according to claim 2, wherein, the rear side of the first positioning groove and a rear side of the second positioning groove are connected with the surface of the guide rail by an arc surface respectively.

4. The horizontal display freezer according to claim 2, wherein, a limiting device is installed on the door body to limit an opening degree of the front door when the freezer opening is opened by the front door, preventing the opening degree of the front door from exceeding a maximum opening state; when the front door is in the maximum opening state, the first guide wheel is located in front of the second positioning groove.

5. The horizontal display freezer according to claim 4, wherein, the limiting device is a handle, installed on a top surface of the front door; a front end of the rear door is overlapped above the front door; when the front door moves until the handle contacts the front end of the rear door, the front door is in the maximum opening state.

6. The horizontal display freezer according to claim 2, wherein, a power buffering device is installed on the freezer body; a shell is installed at the freezer opening, covering the power buffering device; the shell has a communication groove, a protrusion portion is provided on the front door, and the protrusion portion is connected to the power buffering device in the communication groove; during the sliding of the front door, the protrusion portion moves in the communication groove and drives the front door closed gradually under an action of the power buffering device.

7. The horizontal display freezer according to claim 6, wherein, the guide rail includes a first rail segment arranged on the shell and a second rail segment disposed on an inner wall of the freezer body; the first positioning groove is located on the first rail segment, and the second positioning groove is located on the second rail segment.

8. The horizontal display freezer according to claim 7, wherein, an accommodating chamber is defined inside the freezer body; a lower part of the shell protrudes towards the accommodating chamber and forms a support table on a top of the protruding part; a top surface of the support table serves as the first rail segment; an outer side of the support table, away from the accommodating chamber, has a first reinforcing rib, located below the first rail segment.

9. The horizontal display freezer according to claim 6, wherein, the shell is provided with multiple first plug-in plates, and an inner wall of the freezer body is provided with multiple first sockets correspondingly; a shape of each first socket matches with a shape of each first plug-in plate to insert therein, thereby fixing the shell to the freezer body;
the first plug-in plate is provided with a limiting portion; the limiting portion has a first limiting plate transversely arranged and a second limiting plate vertically arranged, intersected with each other; the first limiting plate restricts the shell from moving vertically, and the second limiting plate restricts the shell from moving transversely;
the shell has multiple second sockets, and the inner wall of the freezer body is provided with multiple second plug-in plates correspondingly, being able to insert into the second sockets.

10. The horizontal display freezer according to claim 1, wherein, a front end of the rear door is overlapped above a rear end of the front door; a mounting groove is provided on each left and right sides of the freezer opening respectively; an rear end of the mounting groove extends to a rear side of the freezer body and has an opening end; both sides of the rear door are inserted into corresponding mounting grooves through corresponding opening ends; an edge-pressing strip is installed on the left and right sides of the freezer opening respectively; each edge-pressing strip has a covering portion extending above the front door, to prevent the front door from detaching upwards from the freezer opening.

11. The horizontal display freezer according to claim 10, wherein, a limiting block is installed in a space between a back part of the freezer body and the rear door; the back part of the freezer body presses against the limiting block, and the limiting block presses against a rear end of the rear door, further presses the front end of the rear door against an inner wall of an front end of the mounting groove; the limiting block is mounted on the freezer body by a fastening bolt; the limiting block has a vertically arranged waist hole, through which the fastening bolt passes; by loosening the fastening bolt, the limiting block is able to be raised and lowered relative to the fastening bolt through the waist hole, and leaves the rear end of the rear door, enabling the rear door to be pulled out and removed from the mounting groove through the opening end.

12. The horizontal display freezer according to claim 11, wherein, an assembly window is opened at the rear side of the freezer body; the opening ends of two mounting grooves are exposed through the assembly window, allowing the rear door to insert into the mounting grooves through the assembly window; a cover plate is installed on the assembly window, to close the assembly window.

13. The horizontal display freezer according to claim 10, wherein, a partition installed on the freezer body divides the freezer opening into multiple ones; each divided freezer opening is equipped with the door body; the edge-pressing strip is installed on the partition; a bottom surface of the edge-pressing strip has a downwardly protruding mounting portion, and the mounting portion has an assembly groove; the freezer opening is inserted into the assembly groove, to mount the edge-pressing strip onto the freezer opening;
the edge-pressing strip is fixed to the freezer opening by fixing bolts; the fixing bolts pass through into the assembly groove from one side of the edge-pressing strip and are fixedly connected to the freezer opening; there are multiple fixing bolts; an upper surface of the freezer opening abuts against an inner wall of the assembly groove; when the front door closes the freezer opening, at least one of the fixing bolts is aligned transversely with the front door, so that the front door covers the at least one fixing bolt from a side direction;
a downwardly extending guard plate is provided at two sides of a top surface of the edge-pressing strip respectively; the guard plate is located at an outer side the mounting portion, and is located above the front door; a bottom end of the guard plate is in slidable contact with a top surface of the front door; second reinforcing ribs are installed between the guard plate and the mounting portion; there are multiple second reinforcing ribs arranged from front to rear.

14. The horizontal display freezer according to claim 1, wherein, comprises a locking structure of the door body; the locking structure includes:
a rotating member, a first end of the rotating member at a length direction thereof is rotatably connected to an inner wall of the freezer body, and a second end of the rotating member at the length direction is provided with a first connecting portion;
a locking member, located inside the freezer body and connected with the front door; the locking member is arranged adjacent to the inner wall of the freezer body where the rotating member is arranged; the locking member moves synchronously with the front door; and the locking member has a second connecting portion;
the second connecting portion cooperates with the first connecting portion to prevent a movement of the locking member and the front door, thus locking the front door in an open state.

15. The horizontal display freezer according to claim 14, wherein, the first connecting portion is a connecting hole, and the second connecting portion is a connecting column; the connecting hole is sleeved around an outer periphery of the connecting column, so that the rotating member and locking member are connected with each other.

16. The horizontal display freezer according to claim 14, wherein, the second connecting portion is located on a side of the locking member away from the inner wall of the freezer body where the rotating member is arranged; the rotating member has a bent portion that bends away from the inner wall of the freezer body where the rotating member is arranged; the bent portion is located in a middle part of the rotating member, so that there is a distance between the second end of the rotating member and the inner wall of the freezer body where the rotating member is arranged, allowing the locking member to be disposed therein.

17. The horizontal display freezer according to claim 14, wherein, the inner wall of the freezer body where the rotating member is arranged is also provided with a limiting column; the limiting column is arranged adjacent to the front end of the freezer body and is able to extend and retract relative to the inner wall of the freezer body; the locking member has a limiting hole; by extending and inserting the limiting column into the limiting hole, the front door is locked in a closed state.

18. The horizontal display freezer according to claim 1, wherein, further comprises a camera, installed inside the freezer body below the front door, and configured to capture images of goods in the freezer body.

19. The horizontal display freezer according to claim 1, wherein, a water-blocking table is formed at a front side of the freezer opening; a front end of the front door is located above the water-blocking table; and a drainage groove is provided at a front side of the water-blocking table.

20. A use method of the horizontal display freezer according to claim 2, wherein, comprising the following steps:
S1: pushing the front door backward by a first arm, pushing the first guide wheel out of the first positioning groove, and pushing the second guide wheel out of the second positioning groove;
S2: pushing the front door backward continually by the first arm, pushing both the first guide wheel and the second guide wheel onto the surface of the guide rail and sliding backward along the guide rail, until an open space through which one arm is able to pass is formed between the front end of the front door and the front end of the freezer opening;
S3: holding the front door by the first arm, keeping the front door suspended; reaching into the freezer body through the open space to retrieve goods inside the freezer body by a second arm;
S4: leaving the front door by the first arm, and under the action of gravity of the front door, the first guide wheel and the second guide wheel being sliding forward along the guide rail until falling into the first positioning groove and the second positioning groove respectively, and the freezer opening being closed by the front door.
